(19) United States
(12) Patent Application Publication
(10) Pub. No.: US 2025/0269792 A1
(43) Pub. Date: Aug. 28, 2025

(54) PARKING ASSISTANCE SYSTEM

(71) Applicant: Jeremiah Pringle, Sumter, SC (US)

(72) Inventor: Jeremiah Pringle, Sumter, SC (US)

(21) Appl. No.: 18/589,122

(22) Filed: Feb. 27, 2024

(51) Int. Cl. B60Q 9/00; B60R 1/00; B60R 11/00

(52) U.S. Cl. CPC B60Q 9/00; B60R 1/006; B60R 11/00; B60R 2011/0001

(57) ABSTRACT

A parking assistance system for helping a driver park a vehicle includes a processor, a proximity sensor module, and an indicator. The proximity sensor module is operably coupled to the processor and is configured to detect a distance of the vehicle from a line on a driving surface or an obstacle. An indicator is operably coupled to the processor. The processor is programmed to cause the indicator to present a continue motion signal when the distance of the vehicle from the line or the obstacle is greater than a threshold distance and to cause the indicator to present a stop motion signal when the distance of the vehicle from the line or the obstacle is equal to or less than the threshold distance.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to parking assistance systems and more particularly pertains to a new parking assistance system for sensing markers and obstacles in an environment to assist a driver park with parking a vehicle.

### (2) Description of Related Art including information disclosed under 37 CFR 1.97 and 1.98.

The prior art describes myriad systems which detect markers and obstacles around a vehicle to assist in parking the vehicle. However, the prior art fails to disclose such a system in which an indicator signals to the driver that the driver has room to continue moving the vehicle and sends another signal when a parking space line or obstacle lies immediately next to the vehicle in a direction of motion of the vehicle.

### BRIEF SUMMARY OF THE INVENTION

An embodiment of the disclosure meets the needs presented above by generally comprising a processor, a proximity sensor module, and an indicator. The proximity sensor module is operably coupled to the processor and is configured to detect a distance of the vehicle from a line on a driving surface or an obstacle. An indicator is operably coupled to the processor. The processor is programmed to cause the indicator to present a continue motion signal when the distance of the vehicle from the line or the obstacle is greater than a threshold distance and to cause the indicator to present a stop motion signal when the distance of the vehicle from the line or the obstacle is equal to or less than the threshold distance.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a vehicle with a parking assistance system according to an embodiment of the disclosure.

FIG. 2 is a rear view of a vehicle with an embodiment of the disclosure.

FIG. 3 is a top view of a vehicle with an embodiment of the disclosure.

FIG. 4 is an interior view of a vehicle with an embodiment of the disclosure.

FIG. 5 is a block diagram of an embodiment of the disclosure.

### DETAILED DESCRIPTION OF THE INVENTION

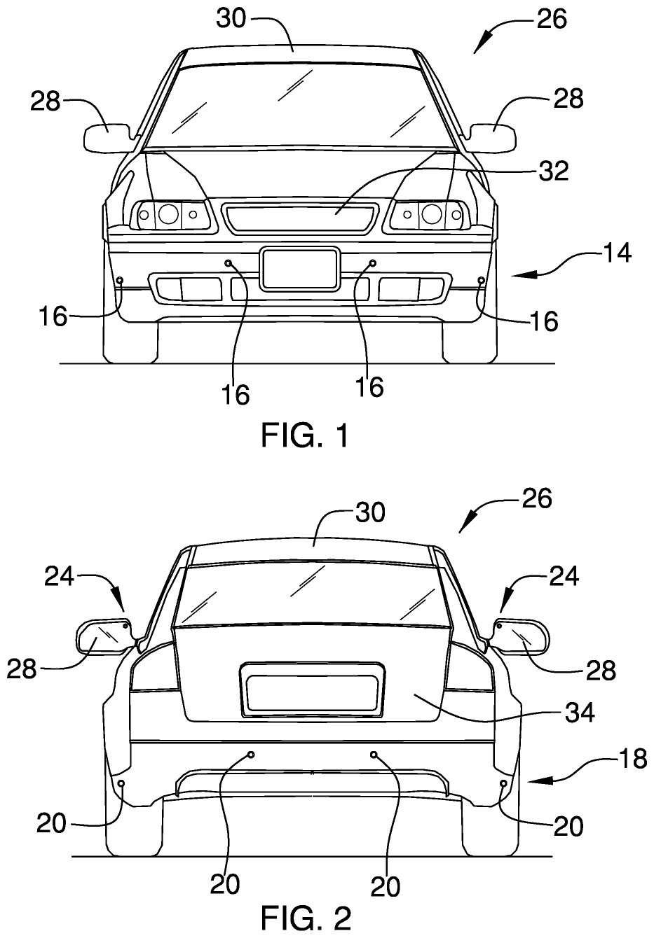

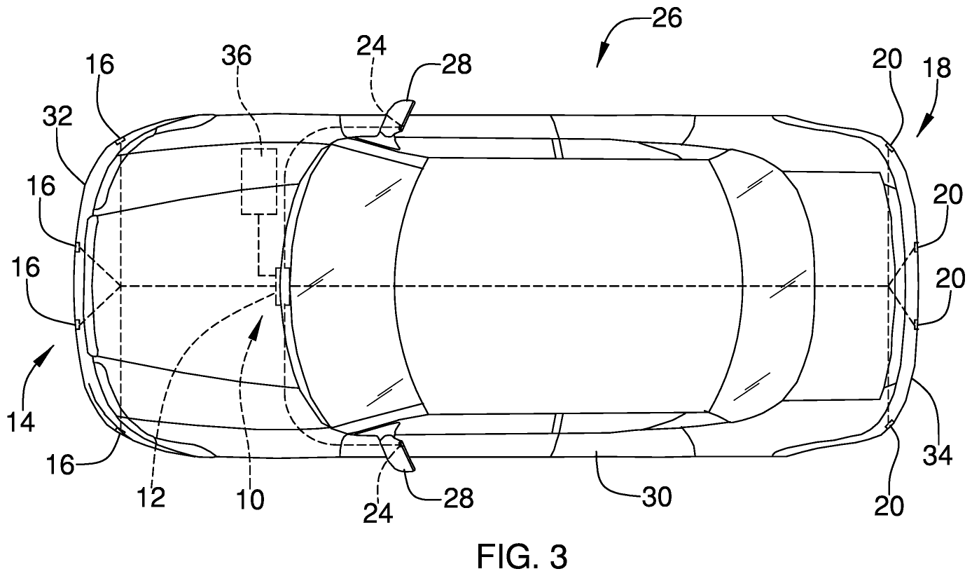

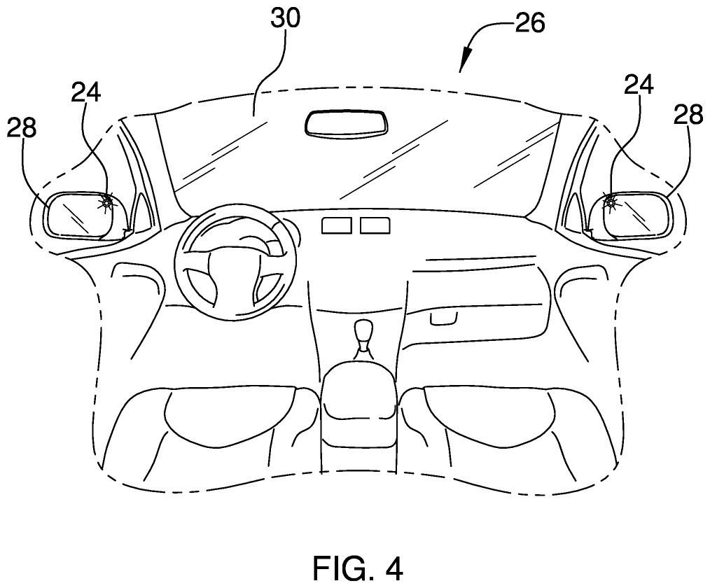

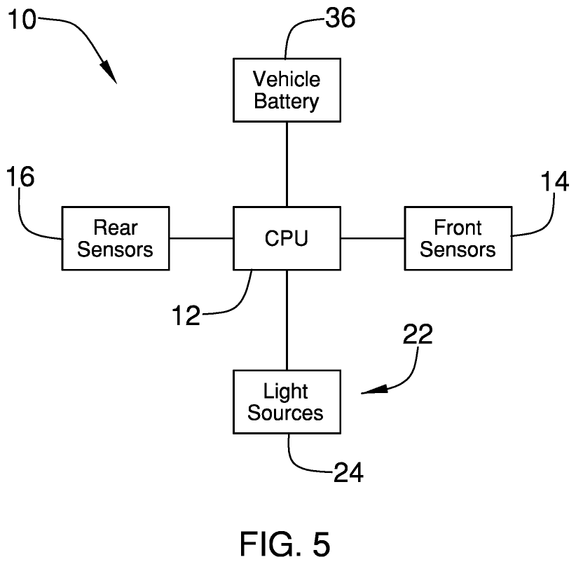

With reference now to the drawings, and in particular to FIGS. 1 through 5 thereof, a new parking assistance system embodying the principles and concepts of an embodiment of the disclosure and generally designated by the reference numeral 10 will be described.

As best illustrated in FIGS. 1 through 5, the parking assistance system 10 is shown as part of a vehicle 26. The parking assistance system 10 comprises a processor 12, a proximity sensor module, and an indicator 22. The proximity sensor module is operably coupled to the processor 12 and is configured to detect a distance of the vehicle 26 from a line on a driving surface or an obstacle. The proximity sensor module comprises a front sensor assembly 14 and a rear sensor assembly 18. The front sensor assembly 14 includes a plurality of front sensor members 16 which are spaced laterally across a front end 32 of a body 30 of the vehicle 26. The rear sensor assembly 18 includes a plurality of rear sensor members 20 which are spaced laterally across a rear end 34 of the body 30. The front sensor members 16 and the rear sensor members 20 may include optical sensor members, laser sensor members, ultrasonic sensor members, radar sensor members, cameras, a combination thereof, or other suitable sensor members for detecting a distance to lines on the driving surface or obstacles. The processor 12 may be used in conjunction with the front and rear sensor members 18, 20 to determine the distance. For example, if cameras are used, the images captured by the cameras may be analyzed via the processor 12 to determine the location of lines or obstacles seen in the images relative to the vehicle 26.

The processor 12 is programmed to cause the indicator 22 to present a continue motion signal when the distance of the vehicle 26 from the line or the obstacle is greater than a threshold distance and a stop motion signal when the distance is less than the threshold distance. When multiple lines or obstacles are detected, the line or obstacle closest to the vehicle 26 may be identified, and the distance to the closest line or obstacle may be used to determine when the indicator 22 presents either the continue motion signal or the stop motion signal. The indicator 22 includes a pair of light sources 24, each of which is mounted to an associated side-view mirror 28 of the vehicle 26. In other embodiments, one or more light sources 24 of the indicator 22 may be positioned in the cabin of the vehicle 26 or another suitable location for the driver to see the light sources 24.

The continue motion signal is represented by a green light shown by the light sources 24, and the stop motion signal is represented by a red light shown by the light sources 24. In some embodiments, each light source 24 may comprise multiple emitters, each of which is capable of emitting one of the green light and the red light. Or multiple filters may be used in conjunction with a light source 24 capable of emitting white light such that the color of the light presented to the driver is red or green as appropriate. Symbols, graphical images, alphanumeric characters, or the like may be presented to the driver to differentiate the continue motion signal from the stop motion signal. In some embodiments, the indicator 22 includes a speaker which emits different sounds for the continue motion and stop motion signals. Any other suitable means of indicating the different signals to the driver may also be used.

The processor 12 is programmed to operate the indicator 22 based on data from the front sensor assembly 14 when the vehicle 26 is operated to move in a forward direction and to operate the indicator 22 based on data from the rear sensor assembly 18 when the vehicle 26 is operated to move in a rearward direction. The processor 12 may determine the direction in which the vehicle 26 is operated via communication with a drivetrain of the vehicle 26, an accelerometer, or other suitable means. The processor 12 is electrically coupled to a battery 36 of the vehicle 26 but may have a separate power source in some embodiments. The processor 12 directs power from the battery 36 to the proximity sensor module and the indicator 22 as required for operation of the same.

The magnitude of the threshold distance may be any distance determined to be sufficient to accurately guide the driver to position the vehicle 26 in a parking space without causing the vehicle 26 to collide with an obstacle. The threshold distance may be, for example, 6.0 inches. In some embodiments, the threshold distance may be selected by the driver via a user interface.

In use, the driver moves the vehicle 26 either forward or rearward into a parking space. When the parking assistance system 10 is activated, the processor 12 causes the indicator 22 to present the continue motion signal when any lines or obstacles detected are determined to be at a distance greater than the threshold distance by the proximity sensor module. The processor 12 causes the indicator 22 to present the stop motion signal when the lines or obstacles detected are determined to be at a distance less than or equal to the threshold distance by the proximity sensor. The processor 12 therefore communicates to the driver to continue traveling along the current trajectory when the continue motion signal is presented and to stop the motion of the vehicle 26 when the stop motion signal is presented in order to prevent collisions with obstacles and position the vehicle 26 within lines delineating the parking space.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A parking assistance system for a vehicle, the system comprising:
a processor;
a proximity sensor module operably coupled to the processor, the proximity sensor module configured to detect a distance of the vehicle from a line on a driving surface or an obstacle; and
an indicator operably coupled to the processor, the processor being programmed to cause the indicator to present a continue motion signal when the distance of the vehicle from the line or the obstacle is greater than a threshold distance, the processor being programmed to cause the indicator to present a stop motion signal when the distance of the vehicle from the line or the obstacle is equal to or less than the threshold distance.

2. The system of claim 1, wherein the indicator comprises a light source.

3. The system of claim 2, wherein the continue motion signal comprises a green light.

4. The system of claim 2, wherein the stop motion signal comprises a red light.

5. The system of claim 1, wherein the proximity sensor module comprises a front sensor assembly and a rear sensor assembly, the processor being programmed to operate the indicator based on data from the front sensor assembly when the vehicle is being operated to move in a forward direction, the processor being programmed to operate the indicator based on data from the rear sensor assembly when the vehicle is being operated to move in a rearward direction.

6. A vehicle comprising a parking assistance system according to claim 1.

7. The vehicle of claim 6, wherein the indicator comprises a light source.

8. The vehicle of claim 7, wherein the continue motion signal comprises a green light.

9. The vehicle of claim 7, wherein the stop motion signal comprises a red light.

10. The vehicle of claim 7, further comprising:
a body having a pair of side-view mirrors, each side-view mirror being positioned on a respective lateral side of a pair of lateral sides of the body; and
wherein the light source is one of a pair of light sources of the indicator, each light source being mounted to a respective one of the pair of side-view mirrors, the processor being programmed to activate each light source of the pair of light sources when operating the indicator.

11. The vehicle of claim 6, further comprising a body, wherein the proximity sensor module comprises a front sensor assembly and a rear sensor assembly, the front sensor assembly being mounted on a front end of the body, the rear sensor assembly being mounted on a rear end of the body, the processor being programmed to operate the indicator based on data from the front sensor assembly when the vehicle is being operated to move in a forward direction, the processor being programmed to operate the indicator based on data from the rear sensor assembly when the vehicle is being operated to move in a rearward direction.

12. The vehicle of claim 11, wherein the front sensor assembly comprises a plurality of front sensor members spaced laterally across the front end of the body, the rear sensor assembly comprising a plurality of rear sensor members spaced laterally across a rear end of the body.

13. The vehicle of claim 6, wherein the vehicle comprises a battery, the processor being electrically coupled to the battery.

14. A method of assisting a driver in parking a vehicle, the method comprising:
detecting, via a proximity sensor module, a distance between the vehicle and a line on a driving surface or an obstacle;
determining, via a processor, whether the distance between the vehicle the line or the obstacle is greater than a threshold distance;
if the distance is greater than the threshold distance, presenting, via an indicator, a continue motion signal to the driver; and
if the distance is not greater than the threshold distance, presenting, via the indicator, a stop motion signal to the driver.

15. The method of claim 14, wherein the indicator comprises a light source.

16. The method of claim 15, wherein the indicator presents a green light via the light source when presenting the continue motion signal.

17. The method of claim 15, wherein the indicator presents a red light via the light source when presenting the stop motion signal.

18. The method of claim 14, wherein the proximity sensor module comprises a front sensor assembly and a rear sensor assembly, the indicator being operated based on data from the front sensor assembly when the vehicle is being operated to move in a forward direction, the indicator being operated based on data from the rear sensor assembly when the vehicle is being operated to move in a rearward direction.

19. The method of claim 18, wherein the front sensor assembly is positioned on a front end of a body of the vehicle, the rear sensor assembly being positioned on a rear end of the body.
